(19) United States
(12) Patent Application Publication
(10) Pub. No.: US 2014/0110068 A1
(43) Pub. Date: Apr. 24, 2014

(54) DRAPERY SUPPORT ASSEMBLY AND METHOD OF MAKING SAME

(71) Applicant: Todd W. Fairchild, Camarillo, CA (US)

(72) Inventor: Todd W. Fairchild, Camarillo, CA (US)

(21) Appl. No.: 13/657,760

(22) Filed: Oct. 22, 2012

(51) Int. Cl. A47H 1/04; B29C 47/00; B32B 37/12; A47H 13/04

(52) U.S. Cl. CPC A47H 1/04; A47H 13/04; B29C 47/00; B32B 37/1284
USPC 160/341; 264/166; 156/66

(57) ABSTRACT

A drapery support assembly includes a head rail having a backing with an upper flange, lower flange and a channel slide holder. The backing, flanges and channel slide holder are integrally formed as the body of the head rail. The assembly includes a channel formed lengthwise within the channel slide holder of the body, and a plurality of channel slides laterally movable within the channel, the channel slides being configured to be attached to drapery hooks for supporting a drapery thereon.

### CROSS-REFERENCE TO RELATED APPLICATION

The present application claims the benefit under 35 U.S.C. §119(e) of U.S. Provisional Patent Application No. 61/608,335 to the inventor, filed Mar. 8, 2012, the entire contents of which is hereby incorporated by reference herein.

### BACKGROUND

1. Field.

Example embodiments in general relate to a drapery support assembly and method of making same for hanging draperies on wall surfaces for covering windows and the like.

2. Related Art

Various temporary coverings for a window or the like have been developed, including an elongated paper-like sheet having equidistant parallel pleats defined by creases extending across the sheet. An adhesive fastening strip is located at the top end along the entire horizontal length of the sheet for fastening the sheet to a window, window frame, or the like. When mounted to a window or window frame, the temporary window covering extends downwardly to a selective variable length, while maintaining a pleated appearance.

However, support assemblies such as head rails for these temporary window coverings, which are typically made out of a lightweight paper product have not heretofore been developed for heavier woven material draperies, valances and shears. A window treatment with fine quality material fashioned into a drape, sheer or valance with associated support hardware can cost in excess of several hundred to over $1,000.00 per window, depending on the size, scope and quality of the treatment. Accordingly, a drapery support assembly that can accommodate finer woven materials which can be installed quickly and efficiently by the end user, at a substantially reduced cost, has not heretofore been developed.

### SUMMARY

An example embodiment is directed to a drapery support assembly. The assembly includes a head rail, a pair of end caps removably attached at ends of the head rail, an adhesive strip on one lengthwise surface, and a channel slide holder on the head rail body on a lengthwise surface opposite the adhesive strip. The channel slide holder includes a channel retaining a plurality of channel slides laterally movable therein and configured to be attached to drapery hooks for supporting a drapery thereon.

Another example embodiment is directed to a drapery support assembly having a head rail including a backing with an upper flange, lower flange and a channel slide holder. The backing, flanges and channel slide holder are integrally formed as the body of the head rail. The assembly includes a channel formed lengthwise within the channel slide holder of the body, and a plurality of channel slides laterally movable within the channel, the channel slides configured to be attached to drapery hooks for supporting a drapery thereon.

Another example embodiment is directed to a method of fabricating a drapery support assembly for hanging a drapery on a wall surface. In the method, a product design is created in software for a mold to fabricate a head rail, the created product design including a head rail having a backing with an upper flange, lower flange and a channel slide holder, the backing, flanges and channel slide holder integrally formed as the body of the head rail, with a channel formed lengthwise within the channel slide holder of the body. The method further includes forming a mold for the head rail based on the created product design, forcing plastic materials through mold via a hot extrusion process to form a tubular head rail that is cooled and cut to size, and forming a pair of end caps and a plurality of channel sides configured to be attached to drapery hooks for supporting a drapery thereon by injection molding. The plurality of channel slides are into the channel of a cooled and cut head rail, and the end caps are attached to the head rail.

Another example embodiment is directed to a method of fabricating a head rail for hanging a drapery on a wall surface. In the method, a product design is created in software for a mold to fabricate a head rail, the created product design including a head rail having a backing with an upper flange, lower flange and a channel slide holder, the backing, flanges and channel slide holder integrally formed as the body of the head rail, with a channel formed lengthwise within the channel slide holder of the body. The method further includes forming a mold for the head rail based on the created product design, and forcing plastic materials through mold via a hot extrusion process to form a tubular head rail that is cooled and cut to size.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1 is a plan view of a drapery support assembly according to an example embodiment.

FIG. 2 is a front view of the drapery support assembly of FIG. 1.

FIG. 3 is an enlarged, close up view of part of the head rail structure to show a splicer for connecting two support assemblies.

FIG. 4 is an enlarged, close up view showing a junction area where two ends of support assemblies are connected by a splicer, so as to see further detail of the channel slides, according to an example embodiment.

FIG. 5 is an end-on view the head rail to show structural details thereof in more detail.

FIG. 6 is a perspective end-on view of one side of the end cap to head rail connection to show structural details thereof in more detail.

FIG. 7 is an end-on view of the end cap to show a Velcro patch for attachment to a drapery.

FIG. 8 is an enlarged, close up rear view showing part of the backing of the assembly to see an adhesive strip embodiment.

FIG. 9 is a partial front view of a drapery attached onto the assembly mounted on a wall surface.

FIG. 10 is a close-up partial view of the drapery installed on the mounted assembly to illustrate hook to channel guide and Velcro connective engagements in more detail.

FIG. 11 shows a drapery fully installed on the drapery support assembly, as mounted on the wall surface.

FIG. 12 is a flowchart illustrating a method of fabricating a drapery support assembly for supporting a drapery thereon.

FIG. 13 is a flowchart illustrating functions of creating a product design in software for molds in more detail.

### DETAILED DESCRIPTION

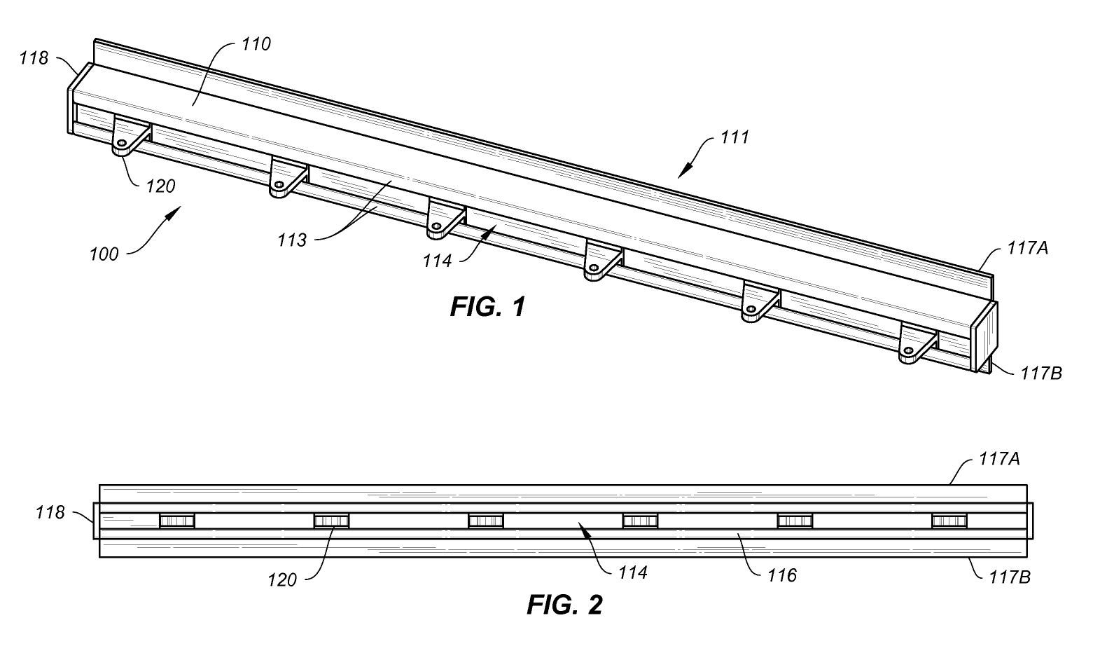

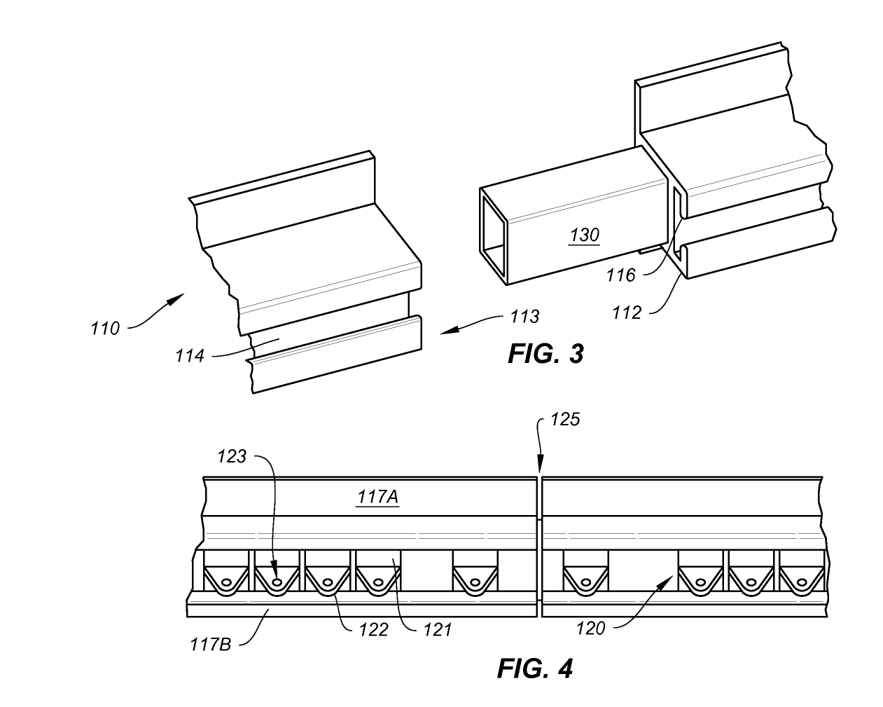

FIG. 1 is a plan view of a drapery support assembly according to an example embodiment; FIG. 2 is a front view of the drapery support assembly of FIG. 1; FIG. 3 is an enlarged, close up view of part of the head rail structure to show a splicer for connecting two support assemblies; and FIG. 4 is an enlarged, close up view showing a junction area where two ends of support assemblies are connected by a splicer, so as to see further detail of the channel slides, according to an example embodiment.

Referring to FIGS. 1-4, there is shown a drapery support assembly 100 (“assembly 100”) for a window, opening, wall, door and the like. Assembly 100 includes a head rail 110 with a backing 111 that includes an adhesive strip 115 (not shown) attached to a rear side thereof for attachment to a wall surface 200. The adhesive may be a bonding strip agent made by 3M®, for example, which adheres to almost any painted surface.

The backing 11 includes a pair of flanges 117A and 117B. In an example, each flange 117A, 117B extends about ½″ above and below a channel slide holder 113, and is designed to lay flush against the wall surface. The flanges 117A, 117B are integral with backing 111, and may include one or more holes therein (not shown), for optional fasteners, if the wall surface is uneven, if additional holding power is desired, and/or if the wall surface is of a material that does not easily accept adhesive strip 115. The head rail 110 includes the channel slide holder 113 integral therewith, the channel slide holder 113 having a lengthwise channel 114 in which is retained a plurality of slidable channel slides 120. The channel slides 120 are adapted to receive hooks 301 (not shown) from a drapery (not shown).

Each head rail 110 includes a pair of end caps 118, each end cap 118 including an adhesive patch 119 on an outer surface thereof. One or more splicers 130 may be provided to connect one or more head rails 110 together, depending on the length of the assembly 100 desired or width of the window space to cover. In one example, assemblies 100 may be employed in 24″, 36″, 48″, 60″ and/or 72″ wide embodiments. Thus for areas requiring greater-width coverage, it may require utilizing two or more assemblies 100 in adjacent relation; hence the use of one or more splicers 130.

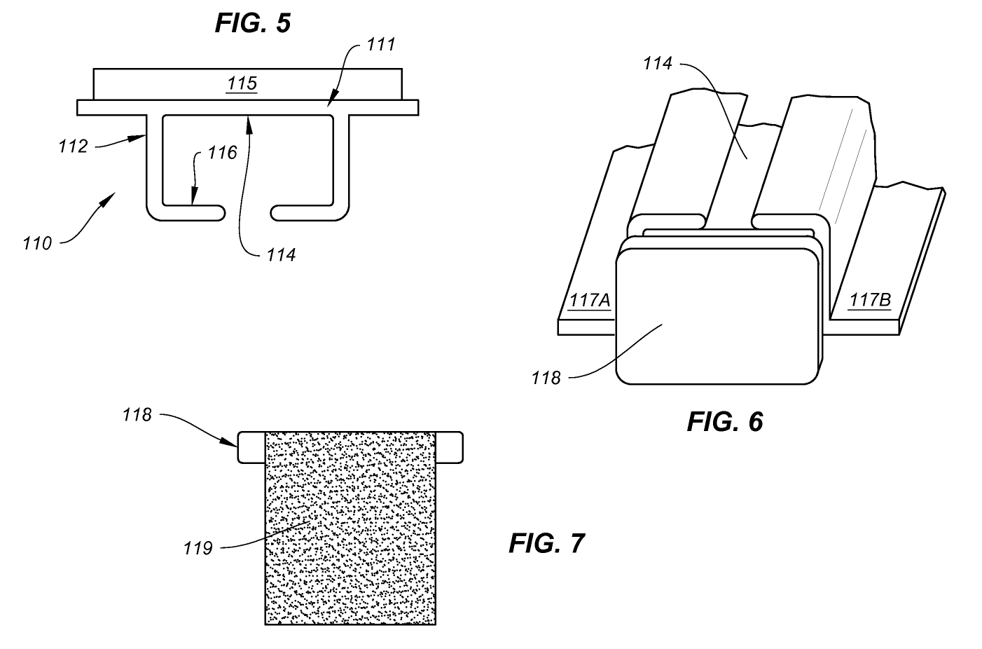

FIG. 5 is an end-on view the head rail to show structural details thereof in more detail; FIG. 6 is a perspective end-on view of one side of the end cap to head rail connection to show structural details thereof in more detail; FIG. 7 is an end-on view of the end cap to show a Velcro patch for attachment to a drapery.

Referring primarily to FIGS. 3-7, the head rail 110 is formed as a single-molded piece and includes a body designed to distribute the weight of a drapery there across, and a channel slide holder 113 that extends along the length of the body. Formed lengthwise support ribs 112 connect the body and backing 111 with flanges 117A, 117B to inward curving retaining lips 116 of the channel slide holder 113.

The channel slide holder 113 includes a lengthwise channel 114 along which the channel slides 120 may laterally move or slide. The channel slide holder 113 has the pair of opposed facing, inward curving retaining lips 116 which extend the length of the head rail 110 that constrain the channel slides 120 within channel 114. This is best shown in FIG. 5. FIG. 5 also shows one example of the adhesive strip 115 on the surface of backing 111 opposite that of the channel slide holder 113. The end cap 118 provided at either end of head rail 110 as shown in FIG. 6 has a mirror image structure, but is dimensioned with tolerances so as to friction fit within the end of head rail 110. The other end of end cap 118 is a planar surface that is affixed with an adhesive patch 119, such as Velcro. This is provided to mate with an opposing patch provided on an inside upper corner surface of a drapery, valance or sheer to obscure the head rail 110 once the drapery is wall mounted thereon.

As also shown in FIG. 4, each channel slide 120 is retained within the channel 114 via the retaining lips 116, but can slidably move along channel 114 within the channel slide holder 113 of head rail 110. The channel slide 120 includes a lower planar base 121 and an upstanding tab 122 perpendicular to the base 121 so that when the head rail 110 is mounted on a wall surface 200, the tab 122 protrudes outward from the wall 200. Each tab 122 includes an aperture 123 for receiving a corresponding hook 301 affixed along the top seam of a drapery, sheer, valance, etc in spaced relation.

As best shown in FIGS. 3 and 4, to extend the overall length of the assembly 100, two or more head rails 110 can be attached using the splicer 130. The splicer 130 is dimensioned so as to friction fit between facing ends of two head rails 110, so that there is a seamless mating between channel slide holders 113 and the adjacent channels 114 thereof.

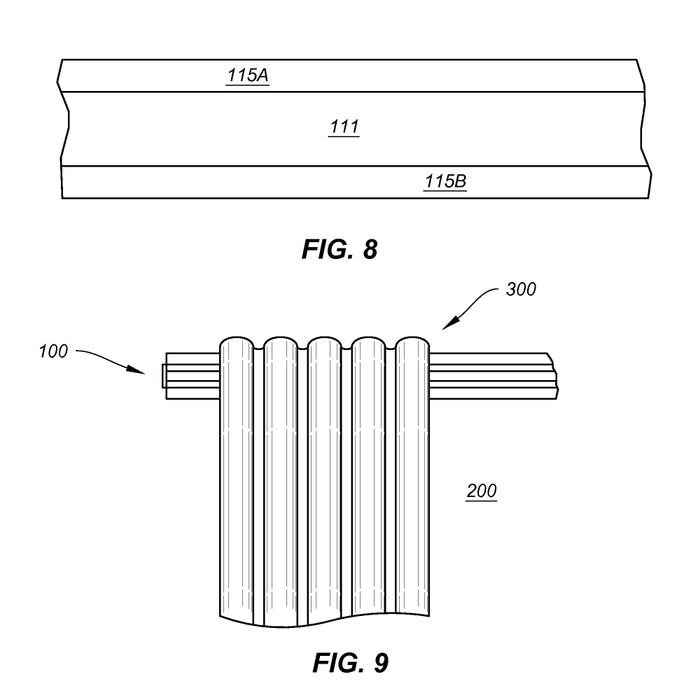

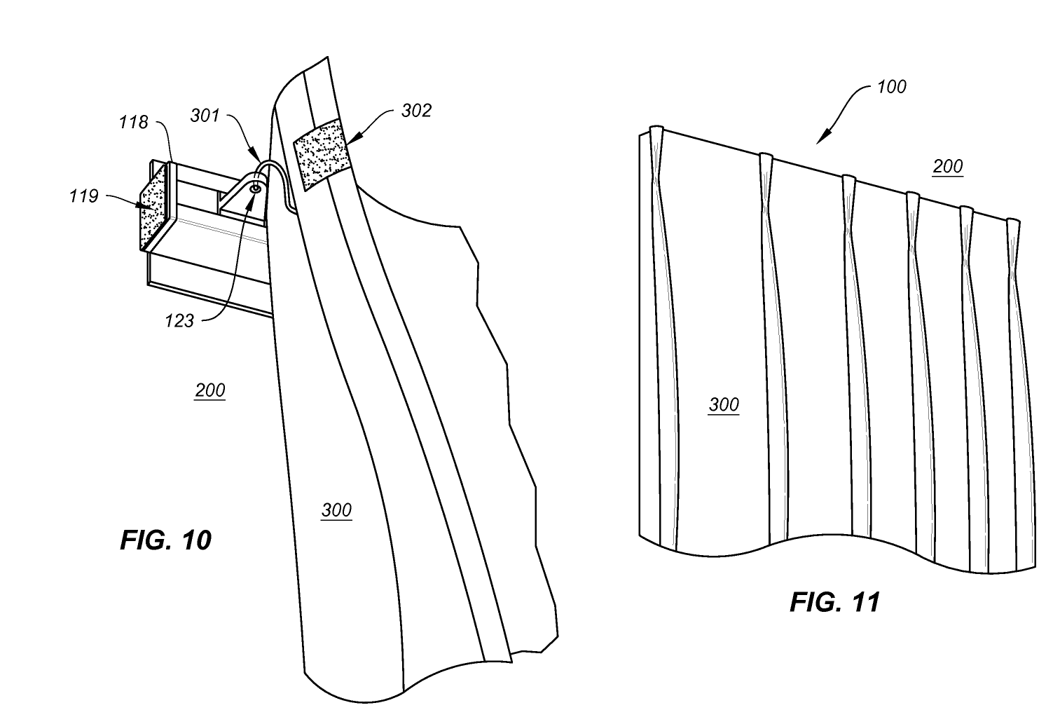

FIG. 8 is an enlarged, close up rear view showing part of the backing of the assembly to see an adhesive strip embodiment; FIG. 9 is a partial front view of a drapery attached onto the assembly mounted on a wall surface; FIG. 10 is a close-up partial view of the drapery installed on the mounted assembly to illustrate hook to channel guide and Velcro connective engagements in more detail; and FIG. 11 shows a drapery fully installed on the drapery support assembly, as mounted on the wall surface.

FIG. 8 shows another variant of adhesive strips, with strips 115A, 115B arranged on rear surfaces of flanges 117A, 117B of backing 11. Referring to FIGS. 9-11, for installation, the user first ensures that the number of channel slides 120 matches the number of hooks 301 on the drapery, valance, sheer, etc. to be mounted. In an example, the assembly 100 could be packaged with an accompanying stylistic, patterned or material drapery, sheer, valance, etc, so this step may not be necessary. In the event that greater or fewer channel slides 120 need to added/removed, one end cap 118 is removed from the end of head rail 110, the slides 120 inserted into the channel with the base 121 aligned between the lips 116, and then the end cap 118 is replaced.

The assembly 100 is then mounted as desired with any necessary leveling on a wall surface 200, as shown in FIG. 9. The drapery 300 may then be attached by inserting the hooks 301 through corresponding apertures 123 in tabs 122, as best shown in FIG. 10. The end corner flaps of the drapery may be affixed with adhesive patches 302 so as to mate with patches 119 on end caps 118. This will obscure the head rail 110, as shown in FIG. 11. In an alternative embodiment, a finial or other decorative trim could be placed over head rail 110 to provide a more decorative looking treatment.

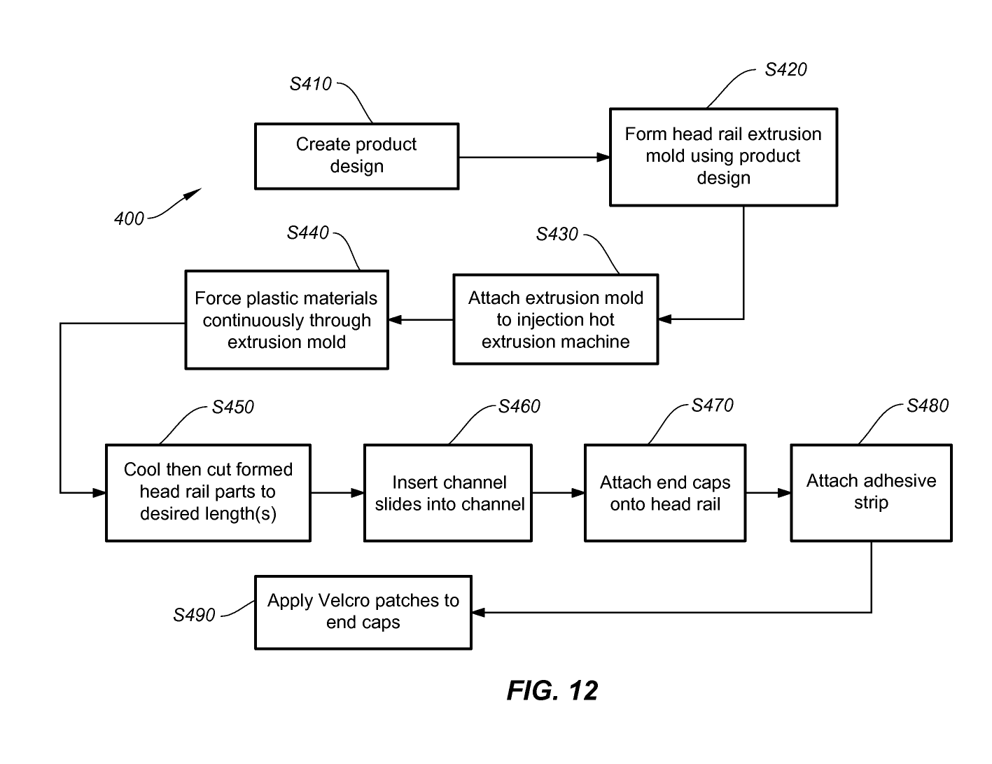

FIG. 12 is a flowchart illustrating a method 400 of fabricating a drapery support assembly for supporting a drapery thereon. The method 400 includes creating a product design (S410) in software for a mold to fabricate the head rail 110. As known, any CAD software design may be used to create the product design from which the mold is to be formed. One example is SOLIDWORKS®. Creating the product design involves developing a number of specific design features in software from which machining centers create the mold.

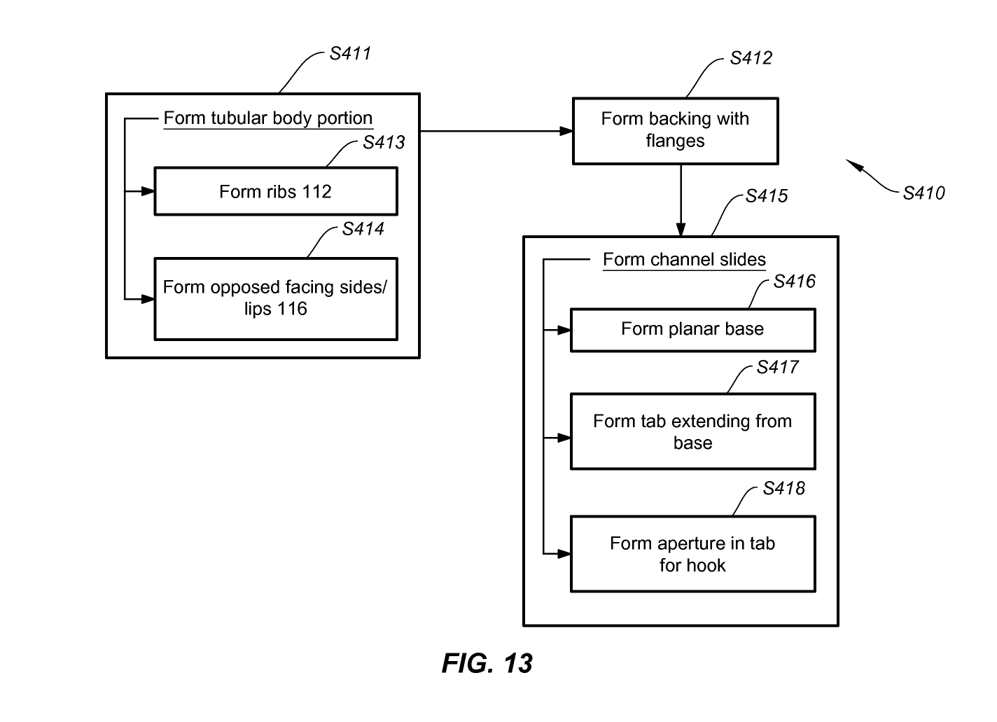

FIG. 13 is a flowchart illustrating functions of creating a product design in software for molds in more detail. Creating the product design at S410 for the drapery support assembly includes the following. Design of these product design features may be done by the designer in no particular order, in software, to include: forming a tubular body portion (S411), forming a backing with upper and lower flanges (S412) having a width extending the length of the tubular body portion, forming the tubular body portion further comprising forming ribs (S413) extending outward from the backing and forming opposed facing sides (S414) from the ribs which extend the length of the tubular portion and which curve inward at an upper end as retaining lips, the ribs and lips creating a lengthwise channel along the body portion.

Creating the product design at S410 further includes forming a plurality of channel slides (S415) slidable in the channel for receiving corresponding hooks of a drapery thereon. Forming each channel slide at S415 further includes forming a planar base (S416) slidable in the channel, forming a tab (S417) extending perpendicular from the base, and forming an aperture (S418) in the tab to receive a hook on a drapery. The channel slide 120, end caps 118 and splicer may be injection molded parts.

Referring again to FIG. 12, method 400 includes forming a mold for the head rail 110 (S420) based on the created product design. This is done by at hot extrusion process. The formed extrusion mold is attached to a hot extrusion machine (S430). A plurality of small ABS pellets are loaded into a metal holder, heated to high temperature to deform and melt as the molten plastic material is forced continuously through the extrusion mold (S440) made for the head rail 110 with integral backing 111. The head rail 110 takes shape is and is slowly cooled and straightened as it continues down the production line. It is then cut at desired lengths (S450). At this point, the head rail 110 manufacturing process is complete.

Accordingly, the head rail 110, splicer 118, channel slides 120, and splicer 130 may be composed of a hard plastic such as TPE, ABS or other synthetic material such as a talc-filled polypropylene, for example. The parts of assembly 100 have been described as being formed hot extrusion and/or an injection molded process. Example processes may include over-molding, insert molding, co-injection molding, etc. The forming process herein is not limited to extrusion or injection molding as other manufacturing methods known to one having ordinary skill in the art, such as a compression process may be used to form assembly 100.

Once the head rail 110 with integral backing 111 has been formed by hot extrusion, and the end caps 118 and channel slides 120 by injection molding, the process is completed (assembly 100 is assembled) by inserting the plurality of channel slides 120 into the channel 114 (S460) of the formed head rail 110, and then attaching the end caps 118 to the head rail 110 (S470) to form the assembly 100 shown in FIGS. 1-11. Thereafter, the adhesive strips 115 such as shown in FIG. 8 may be applied (S480) to the rear surface of the backing 111 (along the top and bottom rear edges of flanges 117A/B), and the Velcro patches 119 may be applied to the surface of end caps 118 (S490) as shown best in FIG. 7. The full assembly 100 is complete.

The example embodiments being thus described, it will be obvious that the same may be varied in many ways. Such variations are not to be regarded as departure from the example embodiments, and all such modifications as would be obvious to one skilled in the art are intended to be included in the following claims.

What is claimed:

1. A drapery support assembly, comprising:
a head rail having a backing with an upper flange, lower flange and a channel slide holder, the backing, flanges and channel slide holder integrally formed as the body of the head rail,
a pair of end caps removably attached at ends of the head rail,
at least one adhesive strip on the backing, and
a channel formed lengthwise within the channel slide holder of the body retaining a plurality of channel slides laterally movable therein, the channel slides configured to be attached to drapery hooks for supporting a drapery thereon.

2. The assembly of claim 1, further comprising:
a splicer for replacing one of the end caps to connect a pair of assemblies together.

3. The assembly of claim 1, further comprising:
a Velcro patch affixed on a surface of the end cap for attachment to a Velcro patch on an upper corner portion of a drapery to obscure the head rail on a wall surface with the drapery installed on the assembly.

4. The assembly of claim 1, wherein the channel slide holder includes
a pair a support ribs formed lengthwise along the body in spaced relation to one another, extending outward from the backing,
the pair a pair facing lips extending from ends of the ribs with a gap there between, the channel formed in the space between adjacent ribs and facing lips.

5. The assembly of claim 4, wherein the end cap has the same rib and lip construction of the channel slide holder.

6. The assembly of claim 1, wherein the channel slide includes:
a base slidable laterally in the channel,
a tab perpendicular to the base so that when the head rail is mounted on a wall surface, the tab protrudes outward from the wall surface, and
an aperture in the tab for receiving a corresponding hook affixed along a top seam of one of a drapery, sheer, and valance.

7. The assembly of claim 1, wherein one of the upper and lower flanges are adapted to receive one or more fasteners there through to add additional support for the assembly into a wall surface.

8. A drapery support assembly, comprising:
a head rail having a backing with an upper flange, lower flange and a channel slide holder, the backing, flanges and channel slide holder integrally formed as the body of the head rail,
a channel formed lengthwise within the channel slide holder of the body, and
a plurality of channel slides laterally movable within the channel, the channel slides configured to be attached to drapery hooks for supporting a drapery thereon.

9. The assembly of claim 8, further comprising:
a splicer for connecting a pair of assemblies together.

10. The assembly of claim 8, further comprising:
a Velcro patch affixed on an end of the head rail body for attachment to a Velcro patch on an upper corner portion of a drapery to obscure the head rail on a wall surface with the drapery installed on the assembly.

11. The assembly of claim 8, wherein the channel slide holder includes:
a pair a support ribs formed lengthwise along the body in spaced relation to one another, extending outward from the backing,
the pair a pair facing lips extending from ends of the ribs with a gap there between, the channel formed in the space between adjacent ribs and facing lips.

11. The assembly of claim 10, further comprising a pair of end caps, wherein each end cap has the same rib and lip construction of the channel slide holder.

12. The assembly of claim 8, wherein the channel slide includes:
a base slidable laterally in the channel,
a tab perpendicular to the base so that when the head rail is mounted on a wall surface, the tab protrudes outward from the wall surface, and
an aperture in the tab for receiving a corresponding hook affixed along a top seam of one of a drapery, sheer, and valance.

13. The assembly of claim 8, wherein one of the upper and lower flanges are adapted to receive one or more fasteners there through to add additional support for the assembly into a wall surface.

14. The assembly of claim 8, further comprising:
a pair of adhesive strips on the backing, one each extending the length of a back surface on each of the upper and lower flanges.

15. A method of fabricating a drapery support assembly for hanging a drapery on a wall surface, comprising:
creating a product design in software for a mold to fabricate a head rail, the created product design including a head rail having a backing with an upper flange, lower flange and a channel slide holder, the backing, flanges and channel slide holder integrally formed as the body of the head rail, with a channel formed lengthwise within the channel slide holder of the body,
forming a mold for the head rail based on the created product design,
forcing plastic materials through mold via a hot extrusion process to form a tubular head rail that is cooled and cut to size,
forming a pair of end caps and a plurality of channel sides configured to be attached to drapery hooks for supporting a drapery thereon by injection molding,
inserting the plurality of channel slides into the channel of a cooled and cut head rail, and
attaching the end caps to the head rail.

16. The method of claim 15, further comprising:
applying an adhesive material to a rear surface of the backing.

17. The method of claim 15, further comprising:
applying Velcro patches to surfaces of each end cap.

18. A method of fabricating a head rail for hanging a drapery on a wall surface, comprising:
creating a product design in software for a mold to fabricate the head rail, the created product design including a head rail having a backing with an upper flange, lower flange and a channel slide holder, the backing, flanges and channel slide holder integrally formed as the body of the head rail, with a channel formed lengthwise within the channel slide holder of the body,
forming a mold for the head rail based on the created product design, and
forcing plastic materials through mold via a hot extrusion process to form a tubular head rail that is cooled and cut to size.

19. The method of claim 18, further comprising:
applying an adhesive material to a rear surface of the backing.

20. The method of claim 18, further comprising:
applying Velcro patches to surfaces of each end cap.
